(19) United States
(12) Patent Application Publication
(10) Pub. No.: US 2008/0266381 A1
(43) Pub. Date: Oct. 30, 2008

(54) Selectively privatizing data transmissions in a video conference

(76) Inventors: Matthew David Smith, Corvallis, OR (US); Douglas A. Pederson, Corvallis, OR (US); Diane R. Hammerstad, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,385

(22) Filed: Apr. 30, 2007

(51) Int. Cl. H04N 7/15

(52) U.S. Cl. 348/14.08; 348/E09.001

(57) ABSTRACT

A method of selectively privatizing data transmissions in a video conference is disclosed. In an embodiment, the method includes initiating a data stream between at least two points in the video conference and selectively privatizing the data stream from one of the at least two points in the video conference to another of the at least two points whereby selectively privatizing the data stream includes altering the data stream to the one of the at least two points.

### BACKGROUND

In a video conference environment for performing an electronic conference through a communication network, a video conference system is provided in each of locations in which participants of a conference come together and a plurality of such video conference systems communicate via the communication network. Each video conference system collects image information and audio information in a location in which the conference system is provided. The image information and the audio information are synthesized and the synthesized information is distributed to the respective conference systems. In each conference system, the image information is displayed on a display device provided in the video conference system and the audio information is outputted through a loudspeaker also provided in the video conference system.

When a video conference is taking place, it can sometimes be helpful to have a private conversation. However, this can sometimes prove to be difficult. For example, in a video conference involving 3 locations, it is problematic for a participant to privately communicate with only 1 of the 3 locations or to hold a private conversation at their own location.

### BRIEF DESCRIPTION OF THE DRAWINGS

FIG. 1 is a high-level flowchart of a method in accordance with an embodiment.

FIG. 2 is an exemplary video conference environment in accordance with an embodiment.

FIG. 3 is a block diagram showing a construction of an exemplary video conference system of the video conference environment in accordance with an embodiment.

### DETAILED DESCRIPTION

As shown in the drawings for purposes of illustration, a method of selectively privatizing data transmissions in a video conference is disclosed. In an embodiment, the method selectively controls audio and/or video signal transmissions between at least two points in the video conference. Accordingly, by selectively controlling the audio and/or video signal transmissions, video conference participants can selectively privatize the audio & video data of the video conference. This adds a unique functionality to the video conferencing environment.

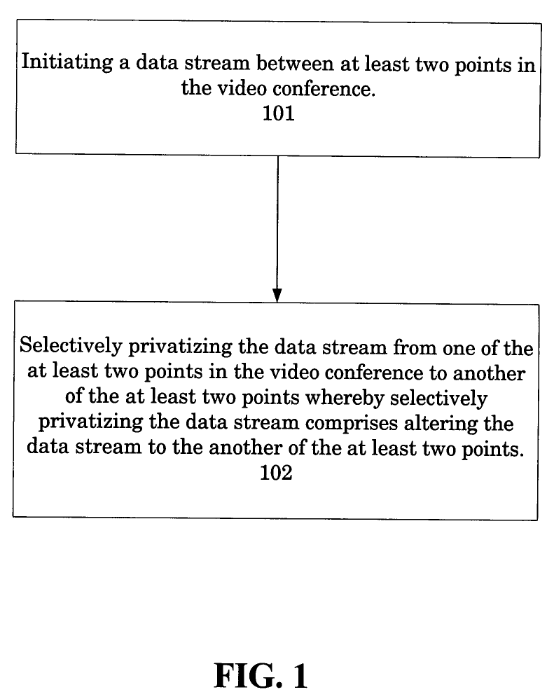

FIG. 1 is a flowchart of a method in accordance with an embodiment. A first step 101 involves initiating a data stream between at least two points in the video conference. A final step 102 involves selectively privatizing the data stream from one of the at least two points in the video conference, whereby selectively privatizing the data stream includes altering the data stream to at least one of the two points. Again, by implementing this feature, a unique functionality to the video conferencing environment is added.

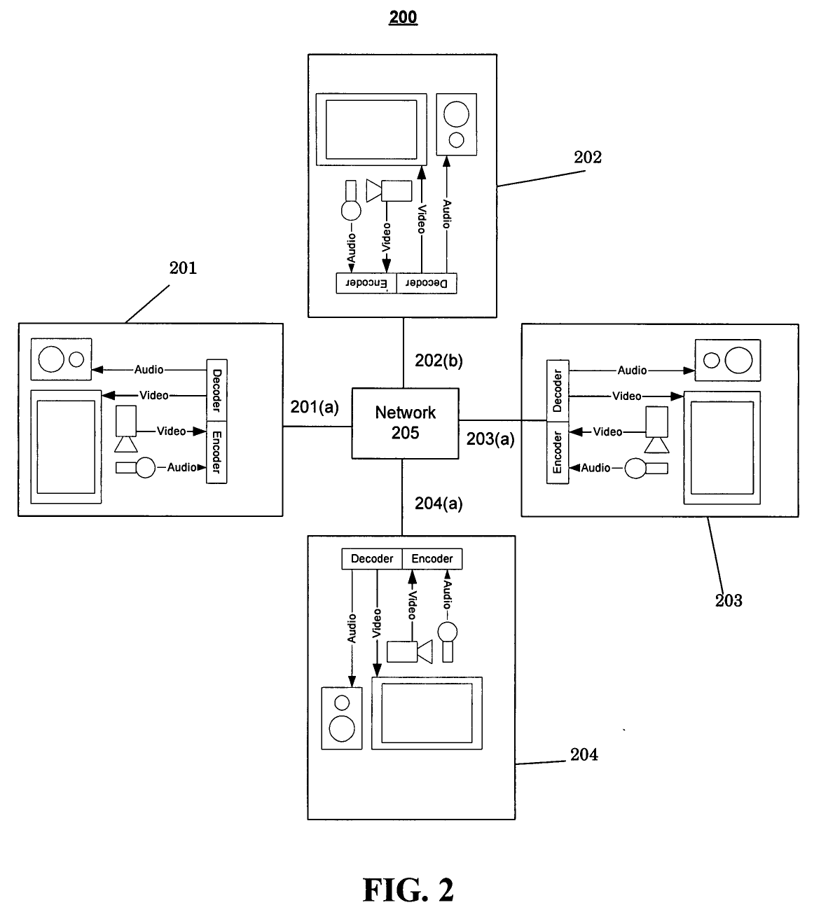

Referring to FIG. 2, an exemplary video conference environment 200 is illustrated. The environment 200 includes multiple video conference systems 201-204 associated with multiple points of the video conference. The respective video conference systems 201-204 are located in different points in the environment 200 and send image and voice data of a video conference through the bi-directional digital transmission paths 201(a)-204(a) and simultaneously receive image and voice data of other video conference systems and display the images and output the voices thereof.

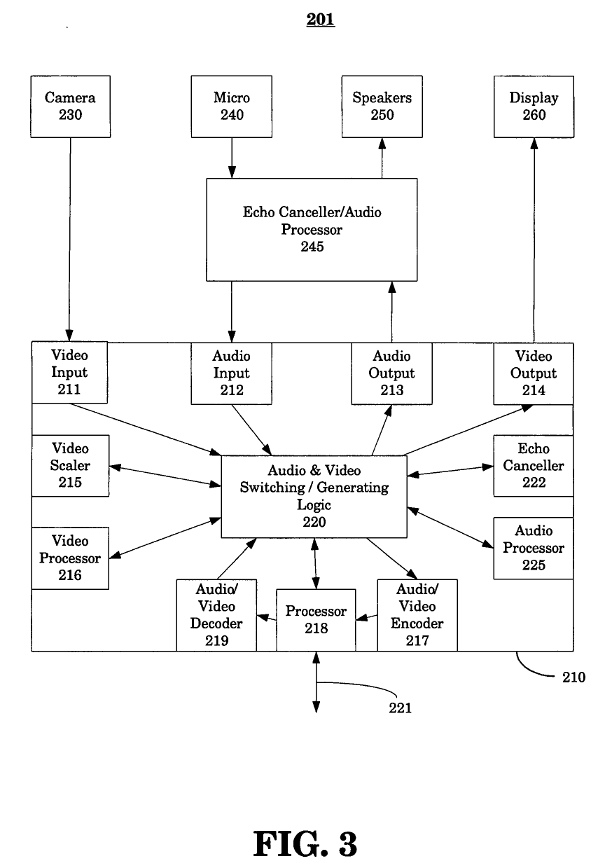

FIG. 3 is a block diagram showing a construction of video conference system 201 of the video conference environment 200. Since the other video conference systems have the same construction as that of the video conference system 201, respectively, only the video conference system 201 need be described.

The video conference system 201 includes an audio/video (A/V) system 210. The A/V system 210 includes a video input 211, an audio input 212, an audio output 213 and a video output 214. The configuration 210 also includes first and second video scalers 215, 216 a video processor 216, an A/V encoder 217, processor 218, A/V decoder 219 and A/V switching and generating logic 220 wherein the A/V switching and generating logic 220 is coupled to an audio echo canceller 222 and an audio processor 225. Bi-directional digital transmission path 221 is configured for transmitting and receiving A/V data over the network 205.

In an embodiment, the network 205 is a system that transmits any combination of voice, video and/or data between users. A network typically includes a network operating system, one or more computer systems, the cables connecting them and all supporting hardware and software in between such as bridges, routers and switches. The network operating system manages the different aspects of the network and makes it possible for the network components to transmit data therebetween.

The A/V system 210 is configured to communicate with a video camera 230 for input of the image of the participant, a microphone 240, a loud-speaker 250 for output of voices of other video conference participant(s) and a for input of a voice of a participant of the video conference and a display 260 for output of the image of another participant(s) of the video conference.

To send audio and video data over a network or to store it on a storage medium, the data is “encoded” or “compressed” since the “raw” or “uncompressed” audio/video data is to large to be feasibly transmitted over the network or store onto a storage medium. Encoding audio/video data significantly reduces the size of the data without significantly affecting the quality of the video. Decoding audio/video data involves “decompressing” the encoded data and thereby converting it into data that can be viewed or processed.

Video conferencing data is created by the video camera 230 and the microphone 240 whereby the microphone 240 creates audio data and the video camera create video data. When this data is encoded and transmitted it is referred to as a “stream”. Usually audio and video streams are combined into one stream herein referred to as an A/V stream.

The A/V switching and generating logic 220 is configured for multiplexing and processing video signals received from video camera 230 via the video input 211 and audio signals received from the microphone 240 via the audio input 212. Additionally, the A/V switching and generating logic 220 transmits decoded A/V signals received from the A/V decoder 219 to the speaker 250 and the display 260 respectively via audio output 213 and video output 214.

The A/V stream is generated from the camera 230 and the microphone 240, respectively. This stream is multiplexed by the A/V switching and generating logic 220 and transmitted to the A/V encoder 217. The encoded A/V data is then transmitted to other video conference participants via the bi-directional digital transmission path 221.

Although the system 201 is described in conjunction with above-delineated components, it should be noted that the system 201 is an exemplary system. One of ordinary skill in the art will readily recognize that a variety of different components could be employed while remaining within the spirit and scope of the inventive concepts. For example, the A/V system 210 is illustrated as a stand alone hardware unit, however the A/V system 210 could be implemented as functional software blocks within a personal computer (PC) system.

In an embodiment, data transmissions can be selectively privatized between one or more participants of the video conference. By selectively privatizing the data transmissions, participants can conduct private communications with select participants of the video conference. A data transmission is “privatized” by deactivating or altering the input/output audio stream and/or the input/output video stream to/from one or more points in the video conference environment. A participant can selectively implement this privatization on a connection-by-connection basis whereby the participant chooses which points in the video conference environment are to be subjected to privatization. For example, if the video conference environment includes four participants (points 1, 2, 3, 4), a participant at point 1 can have a private communication with point 2, by privatizing the audio stream and/or the video stream with respect to points 3 and 4.

### Audio Privatization

Audio data signals are employed by the audio input and output pathways to transmit audio data of a participant. The audio input path includes the A/V switching and generating logic 220, audio echo canceller 222, audio processor 225, audio output 213, audio processing component 245 and speakers 250. The audio output path includes the microphone 240, audio processing component 245, audio input 212, the A/V switching and generating logic 220, audio echo canceller 222 and the audio processor 225. Accordingly, by controlling the audio components, audio data transmissions can be privatized with respect to other video conference participants.

For example, if a participant wants to privatize the outgoing audio data transmission with respect to a particular participant(s), one or more of the components in the audio output path can be deactivated to stop audio data transmissions to other participants in the video conference. These components include the audio processing component 245, audio input 212, the A/V switching and generating logic 220, audio echo canceller 222 and the audio processor 225. Accordingly, the output audio data transmission can be stopped by deactivating one or more of these components. This prevents other participant(s) from hearing any audio from the privatized system.

If the privatizing participant wants to privatize the communication with respect to incoming audio data transmissions, one or more of the components in the audio input path can be deactivated to stop audio data transmissions from other participants in the video conference. These components include the A/V switching and generating logic 220, audio echo canceller 222, audio processor 225, audio output 213 and the audio processing component 245. Accordingly, the input audio data transmission can be stopped by deactivating one or more of these components. This prevents the privatizing participant from hearing any audio from other video conference participants.

Alternatively, the audio data can be privatized by altering the sounds being transmitted. For example, upon activation of the privatization feature, a predetermined audible sound(s) (music, previously recorded privatization message, etc.) can be transmitted via the audio input and output paths respectively instead of the real-time conversation(s). Consequently, upon hearing the predetermined audible sound(s), the privatizing participant is made aware that the audio data transmissions are being privatized with respect to incoming and/or outgoing audio data.

Although the above-listed audio components are described, it should be noted that one of ordinary skill in the art will readily that a variety of different audio components could be employed while remaining within the spirit and scope of the inventive concepts.

### Video Privatization

Video data signals are employed by the video input and output pathways to transmit video data of a video conference participant. The video input path includes second video scaler 216, the A/V switching and generating logic 220, and the video output 214. The video output path includes the camera 230, video input 211, the A/V switching and generating logic 220 and the first video scaler 215. Accordingly, by controlling these components, video data transmissions can be privatized with respect to other video conference participants.

Similar to the audio data privatization, if a participant wants to privatize the video data transmission with respect to a particular participant(s), one or more of the components in the video output path can be deactivated to stop video data transmissions to other participants in the video conference. These components include the video input 211, the A/V switching and generating logic 220 and the first video scaler 215. Accordingly, the output video data transmission can be stopped by deactivating one or more of these components. This prevents other participant(s) from seeing any video images from the privatized system.

If the privatizing participant wants to privatize the communication with respect to incoming video data transmissions, one or more of the components in the video input path can be deactivated to stop video data transmissions from other participants in the video conference from being received by the privatized system. These components include the second video scaler 216, the A/V switching and generating logic 220, and the video output 214. Accordingly, the input video data transmission can be stopped by deactivating one or more of these components. This prevents the privatizing participant from seeing any video images of other video conference participants.

Alternatively, the video image data can be privatized by blurring the video data transmission. This can be accomplished by adjusting various noise reduction settings, transmitting the video data through a filter or blending the video data with another image. Consequently, upon seeing the blurred video image, the privatizing participant is made aware that the video data transmissions are being privatized with respect to incoming and/or outgoing video data.

Although the above-listed video components are described, it should be noted that one of ordinary skill in the art will readily that a variety of different video components could be employed while remaining within the spirit and scope of the inventive concepts.

A method of selectively privatizing data transmissions in a video conference is disclosed. In an embodiment, the method includes initiating a data stream between at least two points in the video conference and selectively privatizing the data stream to one of the at least two points in the video conference whereby selectively privatizing the data stream includes altering the data stream to the one of the at least two points. The method selectively controls audio and/or video signal transmissions. Accordingly, by selectively controlling the audio and/or video signal transmissions, video conference participants can selectively privatize the communication parameters of the video teleconference. This adds a unique functionality to the video conferencing environment.

The above-described embodiment may also be implemented, for example, by operating a computer system to execute a sequence of computer readable instructions. Accordingly, a computing device typically includes at least some form of computer readable media. Computer readable media can be any available media that can be accessed by computing device. By way of example, and not limitation, computer readable media may comprise computer storage media and communications media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage device, or any other medium which can be used to store the desired information and which can be accessed by a computing device.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Accordingly, an alternate embodiment includes a computer readable medium having computer executable components for selectively privatizing data transmissions in a video conference.

Without further analysis, the foregoing so fully reveals the gist of the present inventive concepts that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A method of selectively privatizing data transmissions in a video conference comprising:
initiating a data stream between at least two points in the video conference; and
selectively privatizing the data stream from one of the at least two points in the video conference to another of the at least two points whereby selectively privatizing the data stream comprises altering the data stream to the another of the at least two points.

2. The method of claim 1 wherein the data stream comprises an audio portion and a video portion and altering the data stream further comprises:
altering the audio portion of the data stream.

3. The method of claim 1 wherein the data stream comprises an audio portion and a video portion and altering the data stream further comprises:
altering the video portion of the data stream.

4. The method of claim 1 wherein the data stream comprises an audio portion and a video portion and altering the data stream further comprises:
deactivating the audio and the video portion of the data stream.

5. The method of claim 1 wherein the another of the at least two points comprises a plurality of points and selectively privatizing the data stream to one of the at least two points in the video conference further comprises altering the data stream to the plurality of points.

6. The method of claim 2 wherein an audio path includes a plurality of audio transmitting components and altering the audio portion of the data stream further comprises deactivating at least one of the plurality of audio transmitting components.

7. The method of claim 6 wherein altering the audio portion of the data stream further comprises transmitting a predetermined audible sound.

8. The method of claim 3 wherein a video path includes a plurality of video transmitting components and altering the video portion of the data stream further comprises deactivating at least one of the plurality of video transmitting components.

9. The method of claim 3 wherein altering the video portion of the data stream further comprises blurring the video portion of the data stream.

10. A computer program product for selectively privatizing data transmissions in a video conference, the computer program product comprising a computer usable medium having computer readable program means for causing a computer to perform the steps of:
initiating the data stream between at least two points in the video conference; and
selectively privatizing the data stream from one of the at least two points in the video conference to another of the at least two points whereby selectively privatizing the data stream comprises altering the data stream to the another of the at least two points.

11. The computer program product of claim 10 wherein the data stream comprises an audio portion and a video portion and altering the data stream further comprises:
altering the audio portion of the data stream.

12. The computer program product of claim 10 wherein the data stream comprises an audio portion and a video portion and altering the data stream further comprises:
altering the video portion of the data stream.

13. The computer program product of claim 10 wherein the data stream comprises an audio portion and a video portion and altering the data stream further comprises:
deactivating the audio and the video portion of the data stream.

14. The computer program product of claim 10 wherein the another of the at least two points comprises a plurality of points and selectively privatizing the data stream to one of the at least two points in the video conference further comprises altering the data stream to the plurality of points.

15. The computer program product of claim 11 wherein an audio path includes a plurality of audio transmitting components and altering the audio portion of the data stream further comprises deactivating at least one of the plurality of audio transmitting components.

16. The computer program product of claim 15 wherein altering the audio portion of the data stream further comprises transmitting a predetermined audible sound.

17. The computer program product of claim 12 wherein a video path includes a plurality of video transmitting components and altering the video portion of the data stream further comprises deactivating at least one of the plurality of video transmitting components.

18. The computer program product of claim 16 wherein altering the video portion of the data stream further comprises blurring the video portion of the data stream.

19. A video conference system comprising:
a first point; and
a second point wherein each of the first and second points comprises an audio path wherein the audio path includes a plurality of audio transmitting components, a video path wherein the video path includes a plurality of video transmitting components and an A/V switching and generating logic configured to interact with the audio path and the video to perform the steps of
initiating a data stream between the first point and the second point; and
selectively privatizing the data stream with respect to the second point whereby selectively privatizing the data stream comprises altering the data stream between the first point and the second point.

20. The system of claim 19 wherein selectively privatizing the data stream with respect to the second point further comprises at least one of deactivating at least one of the plurality of audio transmitting components at least one of the first and second points and deactivating at least one of the plurality of video transmitting components at least one of the first and second points.
